(19) United States
(12) Patent Application Publication
(10) Pub. No.: US 2020/0016960 A1
(43) Pub. Date: Jan. 16, 2020

(54) Windshield Shading Assembly

(71) Applicant: Earl Greene, Durham, NC (US)

(72) Inventor: Earl Greene, Durham, NC (US)

(21) Appl. No.: 16/033,713

(22) Filed: Jul. 12, 2018

(51) Int. Cl. B60J 1/20

(52) U.S. Cl. CPC B60J 1/2016; B60J 1/2019; B60J 1/2077

(57) ABSTRACT

A windshield shading assembly for a vehicle includes a housing that is coupled to the vehicle proximate to an upper edge of the vehicle's windshield. The housing extends substantially between opposing side edges of the windshield. A panel is selectively extendible from the housing through a slot in the housing. A slit in the panel extends from a bottom of the panel to proximate to a top of the panel. The slit is configured to part to permit passing of an arm of a rearview mirror as the panel is extended from the housing. An actuator is coupled to the housing and is operationally coupled to the panel. The actuator is positioned to urge the panel through the slot to a deployed configuration. The panel is positioned adjacent to the windshield and is configured to substantially shield an interior space of the vehicle from solar radiation passing through the windshield.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to shading assemblies and more particularly pertains to a new shading assembly for a vehicle.

### BRIEF SUMMARY OF THE INVENTION

An embodiment of the disclosure meets the needs presented above by generally comprising a housing that is coupled to a vehicle proximate to an upper edge of the vehicle's windshield. The housing extends substantially between opposing side edges of the windshield. A panel is selectively extendible from the housing through a slot in the housing. A slit in the panel extends from a bottom of the panel to proximate to a top of the panel. The slit is configured to part to permit passing of an arm of a rearview mirror as the panel is extended from the housing. An actuator is coupled to the housing and is operationally coupled to the panel. The actuator is positioned to urge the panel through the slot to a deployed configuration. The panel is positioned adjacent to the windshield and is configured to substantially shield an interior space of the vehicle from solar radiation passing through the windshield.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a windshield shading assembly according to an embodiment of the disclosure.

FIG. 2 is a cross-sectional view of an embodiment of the disclosure.

FIG. 3 is a rear view of an embodiment of the disclosure.

FIG. 4 is a rear view of an embodiment of the disclosure.

### DETAILED DESCRIPTION OF THE INVENTION

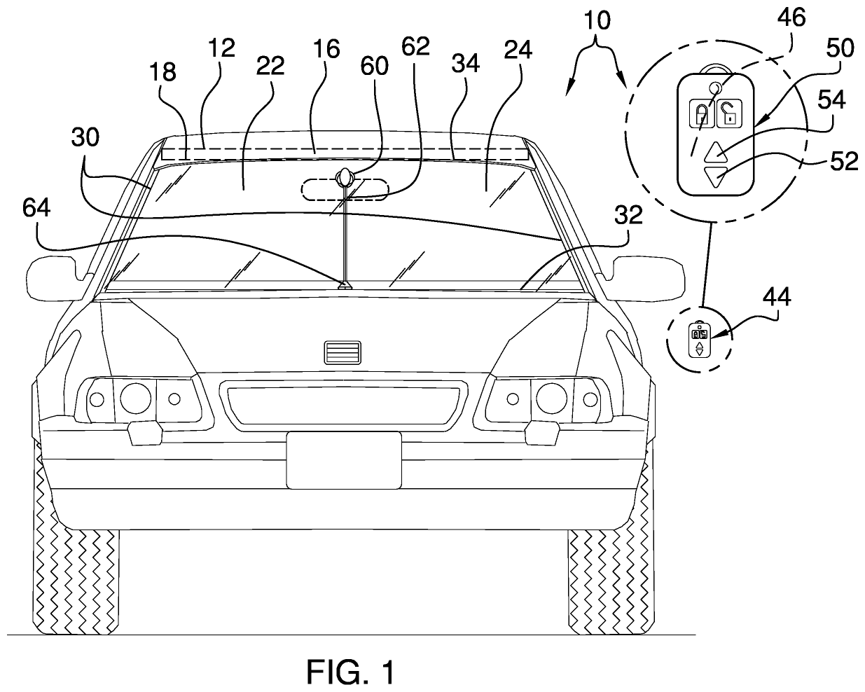

With reference now to the drawings, and in particular to FIGS. 1 through 4 thereof, a new shading assembly embodying the principles and concepts of an embodiment of the disclosure and generally designated by the reference numeral 10 will be described.

As best illustrated in FIGS. 1 through 4, the windshield shading assembly 10 generally comprises a housing 12 that is coupled to a vehicle proximate to an upper edge of a windshield of the vehicle. The housing 12 extends substantially between opposing side edges of the windshield, as shown in FIG. 1. The housing 12 comprises a tube 14. A slot 16 is positioned in a front 18 of the housing 12. The slot 16 extends between opposing ends 20 of the housing 12.

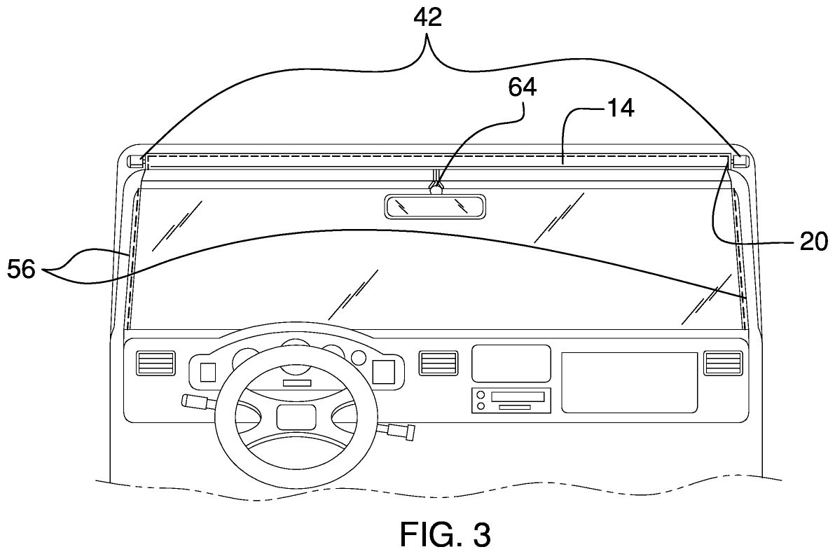

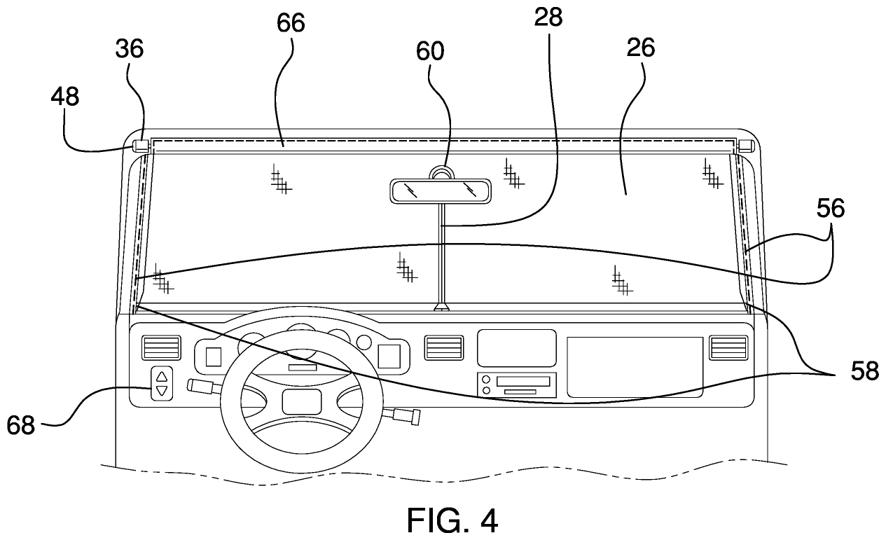

A panel 22 is selectively extendible from the housing 12 through the slot 16, as shown in FIGS. 3 and 4. The panel 22 comprises an outer layer 24 that is disposed on an inner layer 26. The outer layer 24 is substantially reflective of solar radiation. The outer layer 24 comprises aluminum. The outer layer 24 is colored to substantially match a tint of the vehicle. The inner layer 26 comprises at least one of vinyl, cloth, and leather so that the inner layer 26 is configured to complement an interior of the vehicle.

A slit 28 is positioned in the panel 22 substantially equally distant from opposing side rims 30 of the panel 22, as shown in FIG. 1. The slit 28 extends from a bottom 32 of the panel 22 to proximate to a top 34 of the panel 22. The slit 28 is configured to part to permit passing of an arm of a rearview mirror as the panel 22 is extended from the housing 12.

An actuator 36 is coupled to the housing 12. The actuator 36 is operationally coupled to the panel 22. The actuator 36 is positioned to urge the panel 22 through the slot 16 to a deployed configuration wherein the panel 22 is positioned adjacent to the windshield and is configured to substantially shield an interior space of the vehicle from solar radiation passing through the windshield.

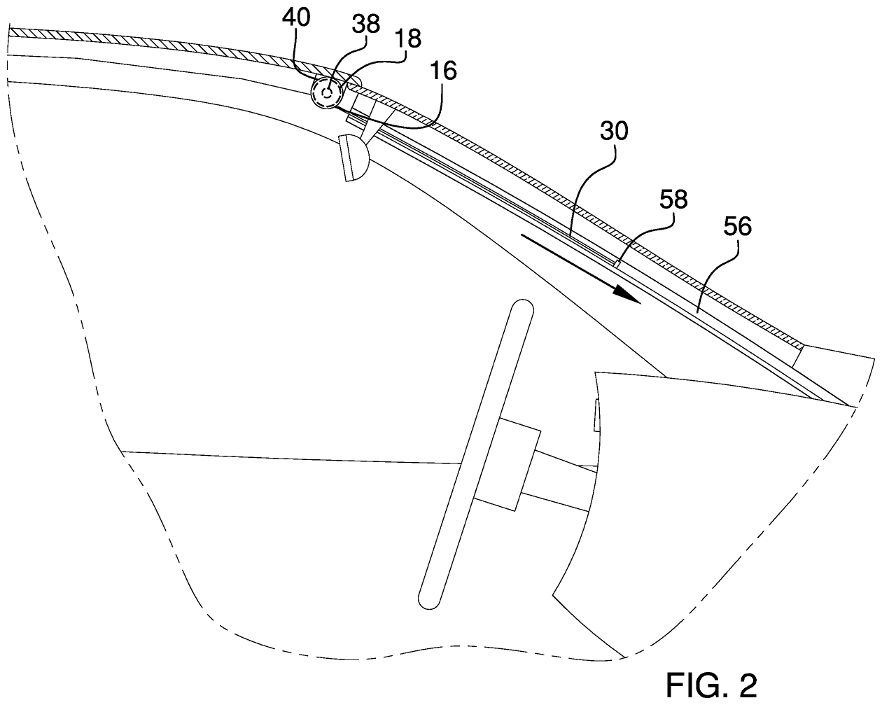

The actuator 36 comprises a spool 38 and a motor 40, as shown in FIG. 2. The spool 38 is positioned in the tube 14. The panel 22 is positioned in a rolled configuration on the spool 38. The motor 40 is coupled to the tube 14. The motor 40 is operationally coupled to the spool 38 and to an electrical circuit of the vehicle. The motor 40 is positioned to selectively rotate the spool 38 to roll the panel 22 from the spool 38 through the slot 16 to the deployed configuration. The motor 40 comprises a pair of servomotors 42. The servomotors 42 are positioned singly at the opposing ends 20 of the housing 12, as shown in FIG. 3.

A controller 44 is operationally coupled to the actuator 36. The controller 44 is positioned to selectively actuate the actuator 36 to urge the panel 22 from the housing 12 to the deployed configuration. The controller 44 comprises a transmitter 46 so that the controller 44 is positioned to transmit commands wirelessly to the actuator 36 through a receiver 48 that is operationally coupled to the actuator 36.

The controller 44 is configured as a fob 50, as shown in FIG. 1, that comprises a first button 52 and a second button 54. The first button 52 and the second button 54 are depressible. The first button 52 is configured to be depressed to signal the actuator 36 to urge the panel 22 from the housing 12 to the deployed configuration. The second button 54 is configured to be depressed to signal the actuator 36 to retract the panel 22 into the housing 12. Having the controller 44 configured as the fob 50 allows a user to actuate the actuator from outside of the vehicle and prevents obstruction of the view of the user while in the vehicle.

Each of a pair of tracks 56 is coupled to a respective A pillar of the vehicle so that the track 56 extends from proximate to the housing 12 to proximate to a lower edge of the windshield, as shown in FIG. 2. Each of a pair of posts 58 is coupled to and extends from a respective opposing side rim 30 of the panel 22 proximate to the bottom 32 of the panel 22. Each post 58 is slidably coupled to an associated track 56. The posts 58 are configured to guide the panel 22 along the tracks 56.

An orifice 60 is positioned through the panel 22 at an upper end 62 of the slit 28, as shown in FIG. 1. The orifice 60 is configured to position the arm of the rearview mirror when the panel 22 is in the deployed configuration.

Each of a pair of cutouts 64 extends into the panel 22 from the bottom 32 and extends to the slit 28, as shown in FIG. 4. Each cutout 64 is triangularly shaped. The pair of cutouts 64 is configured to insert the arm of the rearview mirror to guide the arm to the slit 28 as the panel 22 is extended from the housing 12.

When the assembly 10 is factory-installed, each track 56 is integral to the respective A pillar. The housing 12 may comprise a cavity 66 that is defined by a headliner and a roof of the vehicle. The panel 22 is positioned in a substantially planar configuration within the cavity 66.

Also, when the assembly 10 is factory-installed, the assembly 10 comprises a control module 68 that is integral to a control panel of the vehicle, as shown in FIG. 4. The control module 68 is operationally coupled to the actuator 36. The control module 68 and the controller 44 are positioned to independently and selectively actuate the actuator 36 to urge the panel 22 from the cavity 66 to the deployed configuration.

In use, the first button 52 is depressed to signal the actuator 36 to urge the panel 22 from the housing 12 to the deployed configuration to substantially shield the interior space of the vehicle from the solar radiation passing through the windshield. When the vehicle is to be driven, the second button 54 is depressed to signal the actuator 36 to retract the panel 22 into the housing 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A windshield shading assembly comprising:
a housing coupled to a vehicle proximate to an upper edge of a windshield of the vehicle, the housing extending substantially between opposing side edges of the windshield;
a slot positioned in a front of the housing, the slot extending between opposing ends of the housing;
a panel selectively extendible from the housing through the slot;
a slit positioned in the panel substantially equally distant from opposing side rims of the panel, the slit extending from a bottom of the panel to proximate to a top of the panel wherein the slit is configured for parting to permit passing of an arm of a rearview mirror as the panel is extended from the housing; and
an actuator coupled to the housing, the actuator being operationally coupled to the panel wherein the actuator is positioned for urging the panel through the slot to a deployed configuration wherein the panel is positioned adjacent to the windshield and is configured for substantially shielding an interior space of the vehicle from solar radiation passing through the windshield.

2. The assembly of claim 1, further including the housing comprising a tube.

3. The assembly of claim 1, further including the panel comprising an outer layer disposed on an inner layer, the outer layer being substantially reflective of solar radiation.

4. The assembly of claim 3, further including the outer layer comprising aluminum.

5. The assembly of claim 3, further including the outer layer being colored to substantially match a tint of the vehicle.

6. The assembly of claim 3, further including the inner layer comprising at least one of vinyl, cloth, and leather wherein the inner layer is configured to complement an interior of the vehicle.

7. The assembly of claim 2, further including the actuator comprising:
a spool positioned in the tube, the panel being positioned in a rolled configuration on the spool; and
a motor coupled to the tube, the motor being operationally coupled to the spool and to an electrical circuit of the vehicle wherein the motor is positioned for selectively rotating the spool for rolling the panel from the spool through the slot to the deployed configuration.

8. The assembly of claim 7, further including the motor comprising a pair of servomotors positioned singly at the opposing ends of the housing.

9. The assembly of claim 1, further including a controller operationally coupled to the actuator wherein the controller is positioned for selectively actuating the actuator for urging the panel from the housing to the deployed configuration.

10. The assembly of claim 9, further including the controller comprising a transmitter wherein the controller is positioned for transmitting commands wirelessly to the actuator through a receiver operationally coupled to the actuator.

11. The assembly of claim 10, further including the controller being configured as a fob comprising a first button and a second button, the first button and the second button being depressible wherein the first button is configured for depressing for signaling the actuator for urging the panel from the housing to the deployed configuration and wherein the second button is configured for depressing for signaling the actuator for retracting the panel into the housing.

12. The assembly of claim 10, further comprising:
a pair of tracks, each track being coupled to a respective A pillar of the vehicle such that the track extends from proximate to the housing to proximate to a lower edge of the windshield; and
a pair of posts, each post being coupled to and extending from a respective opposing side rim of the panel proximate to a bottom of the panel, each post being slidably coupled to an associated track wherein the posts are configured for guiding the panel along the tracks.

13. The assembly of claim 1, further including an orifice positioned through the panel at an upper end of the slit wherein the orifice is configured for positioning the arm of the rearview mirror when the panel is in the deployed configuration.

14. The assembly of claim 1, further including a pair of cutouts, each cutout extending into the panel from the bottom and extending to the slit, each cutout being triangularly shaped wherein the pair of cutouts is configured for inserting the arm of the rearview mirror for guiding the arm to the slit as the panel is extended from the housing.

15. The assembly of claim 12, further comprising:
each track being integral to the respective A pillar;
the housing comprising a cavity defined by a headliner and a roof of the vehicle wherein the panel is positioned in a substantially planar configuration within the cavity; and
a control module integral to a control panel of the vehicle, the control module being operationally coupled to the actuator wherein the control module and the controller are positioned for independently and selectively actuating the actuator for urging the panel from the cavity to the deployed configuration.

16. A windshield shading assembly comprising:
a housing coupled to a vehicle proximate to an upper edge of a windshield of the vehicle, the housing extending substantially between opposing side edges of the windshield, the housing comprising a tube;
a slot positioned in a front of the housing, the slot extending between opposing ends of the housing;
a panel selectively extendible from the housing through the slot, the panel comprising an outer layer disposed on an inner layer, the outer layer being substantially reflective of solar radiation, the outer layer comprising aluminum, the outer layer being colored to substantially match a tint of the vehicle, the inner layer comprising at least one of vinyl, cloth, and leather wherein the inner layer is configured to complement an interior of the vehicle;
a slit positioned in the panel substantially equally distant from opposing side rims of the panel, the slit extending from a bottom of the panel to proximate to a top of the panel wherein the slit is configured for parting to permit passing of an arm of a rearview mirror as the panel is extended from the housing;
an actuator coupled to the housing, the actuator being operationally coupled to the panel wherein the actuator is positioned for urging the panel through the slot to a deployed configuration wherein the panel is positioned adjacent to the windshield and is configured for substantially shielding an interior space of the vehicle from solar radiation passing through the windshield, the actuator comprising:
a spool positioned in the tube, the panel being positioned in a rolled configuration on the spool, and
a motor coupled to the tube, the motor being operationally coupled to the spool and to an electrical circuit of the vehicle wherein the motor is positioned for selectively rotating the spool for rolling the panel from the spool through the slot to the deployed configuration, the motor comprising a pair of servomotors positioned singly at the opposing ends of the housing;
a controller operationally coupled to the actuator wherein the controller is positioned for selectively actuating the actuator for urging the panel from the housing to the deployed configuration, the controller comprising a transmitter wherein the controller is positioned for transmitting commands wirelessly to the actuator through a receiver operationally coupled to the actuator, the controller being configured as a fob comprising a first button and a second button, the first button and the second button being depressible wherein the first button is configured for depressing for signaling the actuator for urging the panel from the housing to the deployed configuration and wherein the second button is configured for depressing for signaling the actuator for retracting the panel into the housing;
a pair of tracks, each track being coupled to a respective A pillar of the vehicle such that the track extends from proximate to the housing to proximate to a lower edge of the windshield;
a pair of posts, each post being coupled to and extending from a respective opposing side rim of the panel proximate to a bottom of the panel, each post being slidably coupled to an associated track wherein the posts are configured for guiding the panel along the tracks;
an orifice positioned through the panel at an upper end of the slit wherein the orifice is configured for positioning the arm of the rearview mirror when the panel is in the deployed configuration; and
a pair of cutouts, each cutout extending into the panel from the bottom and extending to the slit, each cutout being triangularly shaped wherein the pair of cutouts is configured for inserting the arm of the rearview mirror for guiding the arm to the slit as the panel is extended from the housing.

17. The assembly of claim 16, further comprising:
each track being integral to the respective A pillar;
the housing comprising a cavity defined by a headliner and a roof of the vehicle wherein the panel is positioned in a substantially planar configuration within the cavity; and
a control module integral to a control panel of the vehicle, the control module being operationally coupled to the actuator wherein the control module and the controller are positioned for independently and selectively actuating the actuator for urging the panel from the cavity to the deployed configuration.
